(19) United States
(12) Patent Application Publication
(10) Pub. No.: US 2006/0082696 A1
(43) Pub. Date: Apr. 20, 2006

(54) Liquid crystal display apparatus

(76) Inventor: Sung-gi Kim, Suwon-si (KR)

Correspondence Address: STANZIONE & KIM, LLP, 919 18TH STREET, N.W., SUITE 440, WASHINGTON, DC, 20006, US

(21) Appl. No.: 11/234,174

(22) Filed: Sep. 26, 2005

(30) Foreign Application Priority Data
Oct. 20, 2004 (KR) 2004-83892

(51) Int. Cl. G02F 1/1333

(52) U.S. Cl. 349/58

(57) ABSTRACT

A liquid crystal display apparatus includes a front cover on which an opening edge is formed, a display panel provided on a back of the front cover, a screen protector provided between the front cover and the display panel to protect the display panel, and a rear cover coupled to the back of the front cover. Thus, the liquid crystal display apparatus may have a simplified installation structure of the screen protector.

### CROSS-REFERENCE TO RELATED APPLICATIONS

This application claims the benefit of Korean Patent Application No. 2004-83892, filed on Oct. 20, 2004, in the Korean Intellectual Property Office, the disclosure of which is incorporated herein by reference.

### BACKGROUND OF THE INVENTION

1. Field of the Invention

The present general inventive concept relates to a liquid crystal display apparatus, and more particularly, to a liquid crystal display apparatus having an improved installation structure of a screen protector.

2. Description of the Related Art

Recently, a liquid crystal display apparatus as a kind of a flat panel display apparatus is increasingly used as a computer monitor, a television, etc., and demands therefor are also rising.

A conventional liquid crystal display apparatus comprises a front cover on which an opening is formed, a display panel provided on a back of the front cover and displaying a picture, and a rear cover provided on a back of the display panel and coupled with the front cover.

On a front surface of the front cover is provided a screen protector made of a material such as reinforced glass capable of safely protecting the display panel from external circumstances, and the liquid crystal display apparatus having such a structure is disclosed in Korean Patent First Publication No. 2004-20154. According to this strucutre, an improved screen protector is applied to this liquid crystal display apparatus by forming various coating layers on a surface of a tempered glass.

However, in the foregoing liquid crystal display apparatus, the screen protector is provided in front of the front cover. Thus, an extra part is required to install the screen protector, and an installation structure thereof is complicated.

Further, as the screen protector is protrudingly formed on the surface of the front cover, the liquid crystal display apparatus relatively increases in volume, and an external appearance and design thereof becomes complicated.

### SUMMARY OF THE INVENTION

The present general inventive concept to provide a liquid crystal display apparatus having a simplified installation structure of a screen protector.

Additional aspects and/or advantages of the present invention will be set forth in part in the description which follows and, in part, will be obvious from the description, or may be learned by practice of the present invention.

The foregoing and/or other aspects and advantages of the present general inventive concept may be achieved by providing a liquid crystal display apparatus comprising a front cover on which an opening edge is formed, a display panel provided on a back of the front cover, a screen protector provided between the front cover and the display panel to protect the display panel, and a rear cover coupled to the back of the front cover.

On a front surface edge of the screen protector may be formed a movement preventing protrusion, which is supported by the opening edge of the front cover.

The screen protector may comprises an acrylic sheet, an AG coating layer formed on a surface of the acrylic sheet, and an AR coating layer formed on a surface of the AG coating layer.

The screen protector may further comprise a fluorine coating layer formed on a surface of the AR coating layer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a liquid crystal display apparatus according to an embodiment of the present general inventive concept;

FIG. 2 is an exploded perspective view illustrating the liquid crystal display apparatus of FIG. 1;

FIG. 3 is a partial sectional view illustrating an installation structure of a screen protector of the liquid crystal display apparatus of FIG. 1;

FIG. 4 is a sectional view illustrating a screen protector used with a liquid crystal display apparatus according to an embodiment of the present general inventive concept;

FIG. 5 is a sectional view illustrating a screen protector used with a liquid crystal display apparatus according to an embodiment of the present general inventive concept; and

FIGS. 6A through 6E are views illustrating an opening edge formed on the screen protector of FIGS. 4 and 5.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

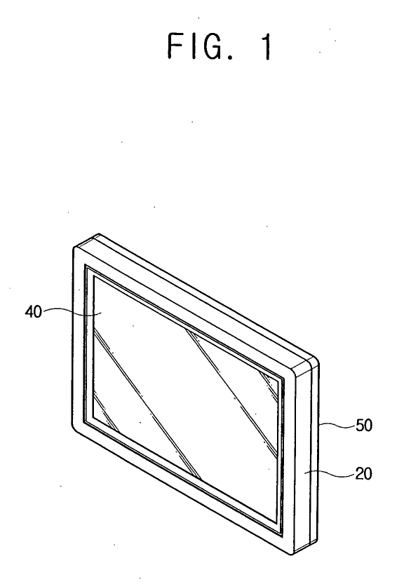

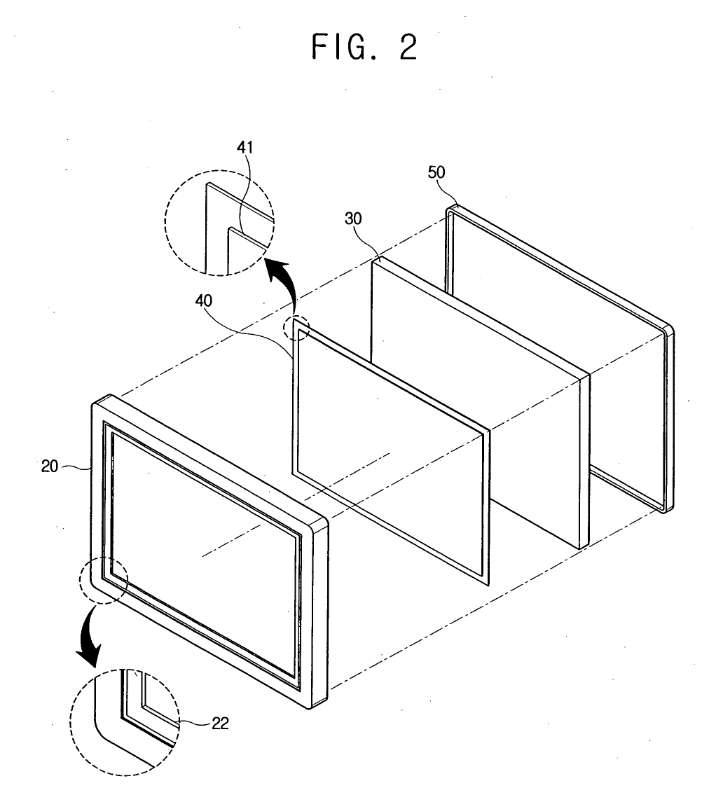

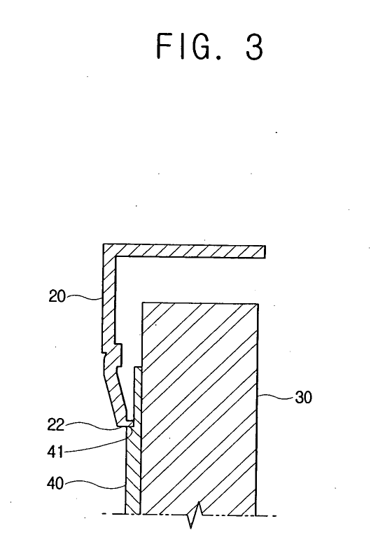

As shown in FIGS. 1 through 3, a liquid crystal display apparatus according to an embodiment of the present general inventive concept comprises a front cover 20, a display panel 30 provided on a back of the front cover 20 to display a picture, a screen protector 40 provided between the front cover 20 and the display panel 30 to protect the display panel 30, and a rear cover 50 provided on a back of the display panel 30 and coupled with the front cover 40.

An opening edge 22 of the front cover 20 protrudes backward. A movement preventing portion 41 is formed on a front surface edge of the screen protector 40, which is supported by the opening edge 22 of the front cover 20 and prevents the screen protector 40 from randomly moving. Accordingly, the screen protector 40 stably maintains a supported state through a combination of the opening edge 22 and the movement preventing protrusion 41 without an extra supporting part.

The screen protector 40 may not protect the display panel 30 from an external shock and a malfunctioning due to introduction of an external substance, such as water, etc.

The front surface edge of the screen protector 40 may be changed into various shapes as long as the combination with the opening edge 22 of the front cover 20 is firmly and stably maintained. For example, the front surface edge of the screen protector 40 may be formed as a groove to accommodate and support the opening edge 22 of the front cover 20.

The front cover 20 includes an opening defined by the opening edge 22, and an outside surface of the screen protector 40 is exposed through the opening to display an image of the display panel 30. The front cover 20 further includes a side substantially parallel to the outside surface of the screen protector 40, and the opening edge 22 is formed on a distal end of the side of the front cover 20. In addition, the opening edge 22 includes a distal end to protrude from the side toward the movement preventing portion 41. A shape of the distal end of the opening edge 22 may correspond to the movement preventing portion 41 so that the movement preventing portion 41 is firmly supported by the opening edge 22.

The movement preventing portion 41 may be a step or a notch formed on the screen protector 40 or may be formed as a protrusion which protrudes from a surface of the screen protector 40, so that a movement of the screen protector 40 is prevented by the opening edge 22. In addition, the display panel 30 is supported with respect to the front cover 20 and the rear cover 50 using the combination of the movement preventing portion 41 of the screen protector 40 and the opening edge 22 of the front cover 20.

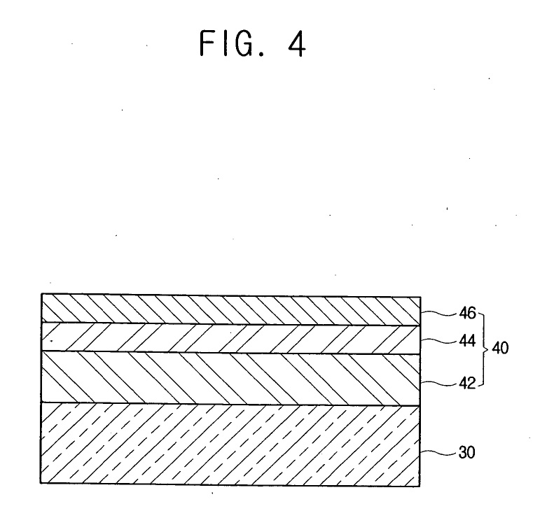

As shown in FIG. 4, the screen protector 40 comprises an acrylic sheet 42, an anti-glare (AG) coating layer 44 formed on a surface of the acrylic sheet 42, and an anti-reflection (AR) coating layer 46 formed on a surface of the AG coating layer 44.

The acrylic sheet 42 prevents the display panel 30 from being damaged by the external shock. The AG coating layer 44 and the AR coating layer 46 prevent a surface reflection of the acrylic sheet 42 due to light. Particularly, the AR coating layer 46 compensates for a weakness of the AG coating layer 44 which may make a picture displayed on the display panel 30 unclear.

As the AR coating and the AG coating are well known, the detailed description thereof will be avoided, and the front cover 20 is coupled with the rear cover 50 by a coupling part such as a screw, etc.

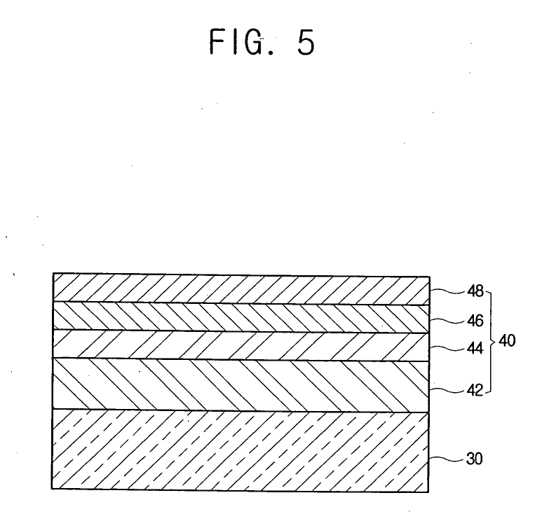

As shown in FIG. 5, the screen protector 40 may further comprise a fluorine coating layer 48, the AR coating layer 46, the AG coating layer 44 sequentially formed on the surface of the acrylic sheet 42. The fluorine coating layer 48 improves a function of the screen protector 40 using characteristics of fluorine which is relatively superior in corrosion resistance, non-stickiness, abrasion resistance, etc., from a low temperature to a high temperature.

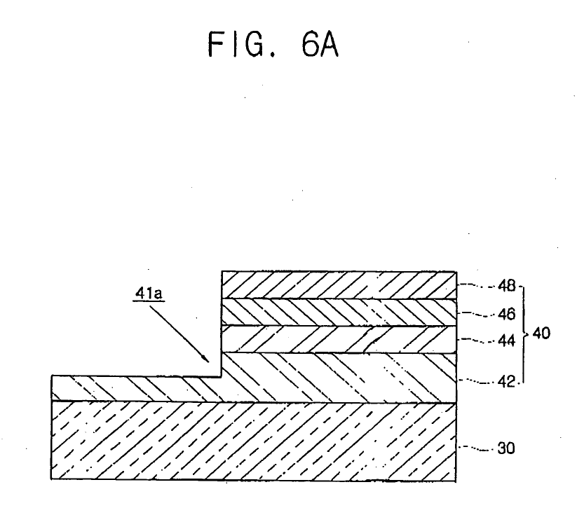

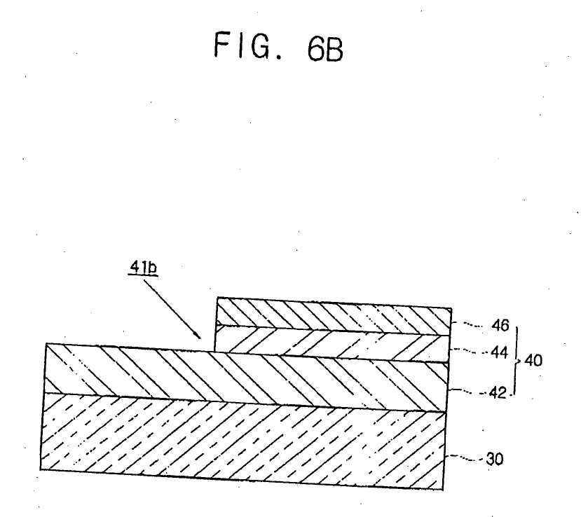

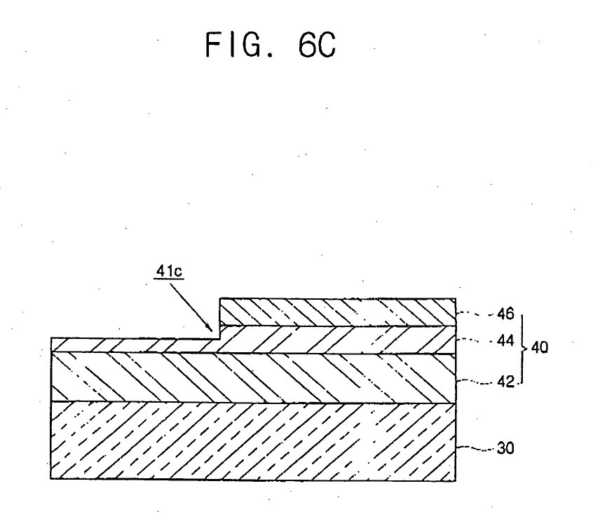

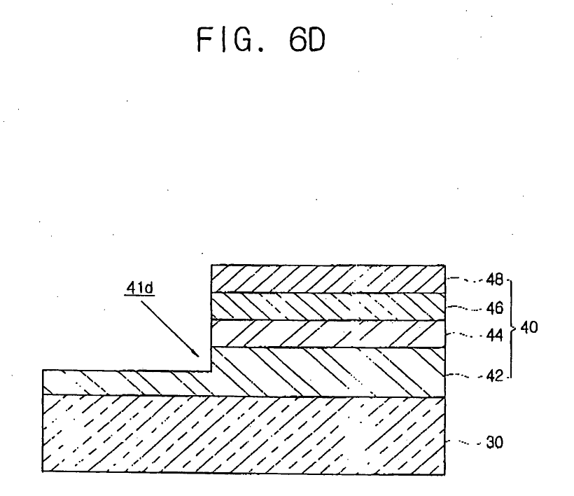

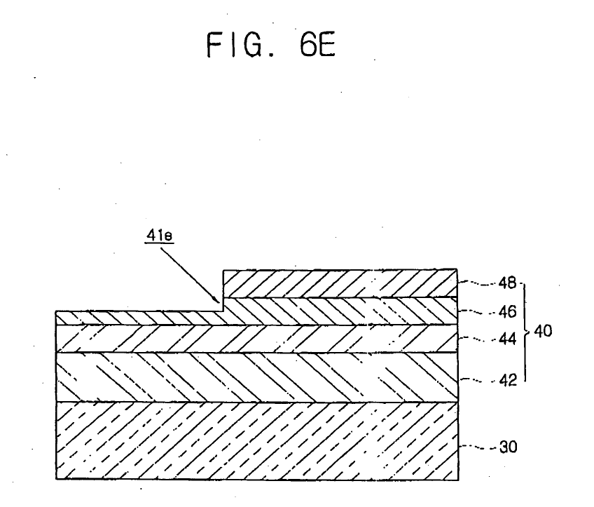

FIGS. 6A through 6E illustrate various types of movement preventing portions 41a, 41b, 41c, 41d, and 41e formed on the screen protector 40 of FIGS. 4 and 5, respectively. As shown in FIGS. 6A through 6E, the opening edges 41a, 41b, 41c, 41d, and 41e are formed on either the acrylic sheet 42, the AG coating layer 44, the AR coating layer 46, or the fluorine layer 48. A portion of the movement preventing portions 41a, 41b, 41c, 41d, and 41e, which is not exposed but covered and supported by the opening edge 22, may be coated with the AG coating layer the AG coating layer 44, the AR coating layer 46, or the fluorine layer 48. However, a structure of the movement preventing portions 41a, 41b, 41c, 41d, and 41e is not limited thereto. Any structure to correspond to the opening edge 22 of the front cover 20 may be used to support the display panel 30 with respect to the front cover 20 and the rear cover 50.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A liquid crystal display apparatus comprising:
a front cover on which an opening edge is formed;
a display panel provided on a back of the front cover;
a screen protector provided between the front cover and the display panel, supported by the opening edge of the front cover, and to protect the display panel; and
a rear cover coupled to the back of the front cover.

2. The liquid crystal display apparatus according to claim 1, wherein the screen protector comprises a movement preventing portion formed on a front surface edge thereof, and the movement preventing portion is supported by the opening edge of the front cover.

3. The liquid crystal display apparatus according to claim 1, wherein the screen protector comprises an acrylic sheet, an AG coating layer formed on a surface of the acrylic sheet, and an AR coating layer formed on a surface of the AG coating layer.

4. The liquid crystal display apparatus according to claim 3, wherein the screen protector further comprises a fluorine coating layer formed on a surface of the AR coating layer.

5. A liquid crystal display apparatus comprising:
a first cover;
a second cover coupled to the front cover;
a display panel disposed between the first cover and the second cover to display an image thereon;
a screen protector formed on a display surface of the display panel, and having an outside surface disposed opposite to the display surface of the display panel;
a movement preventing portion formed on an outside surface of the screen protector; and
an opening edge formed on the front cover and coupled to the movement preventing portion of the screen protector to support a combination of the display panel and the screen protector with respect to the first cover and the second cover.

6. The liquid crystal display apparatus according to claim 5, wherein the screen protector comprises:
a sheet formed on the display surface of the display panel;
a first coating layer formed on a surface of the sheet opposite to the display surface of the display panel; and
a second coating layer formed on a surface of the first coating layer opposite to the sheet, and having the outside surface disposed opposite to the surface of the first coating layer,
wherein the movement preventing portion is formed on a portion of at least one of the sheet, the first coating layer, and the second coating layer, the portion spaced-apart from the display surface of the display panel by a first distance from the display panel different from a second distance between the outside surface of the second coating layer and the display surface of the display panel.

7. The liquid crystal display apparatus according to claim 5, wherein the second coating layer comprises a fluorine coating layer and one of an AG coating layer and an AR coating layer.

8. The liquid crystal display apparatus according to claim 5, wherein the screen protector comprises:
a coating layer formed on the display surface of the display panel, and having the outside surface,
wherein the movement preventing portion is formed on a portion of the coating layer, and the portion of the coating layer is spaced-apart from the display surface of the display panel by a first distance from the display panel different from a second distance between the outside surface of the second coating layer and the display surface of the display panel.

9. The liquid crystal display apparatus according to claim 5, wherein the outside surface of the screen protector is parallel to the display surface of the display panel.

10. The liquid crystal display apparatus according to claim 5, wherein the first cover comprises an opening defined by the opening edge, and a portion of the outside surface is exposed through the opening of the first cover to display an image.

11. The liquid crystal display apparatus according to claim 5, wherein the front cover comprises a side parallel to the outside surface of the screen protector, and the opening edge is formed on a distal end of the side.

12. The liquid crystal display apparatus according to claim 5, wherein the opening edge comprises a distal end to protrude from the portion toward the movement preventing portion.

13. The liquid crystal display apparatus according to claim 5, wherein the opening edge is not disposed on a plane of the outside surface of the screen protector.

14. The liquid crystal display apparatus according to claim 5, wherein a shape of the opening edge of the front cover corresponds to the movement preventing portion.

15. The liquid crystal display apparatus according to claim 5, wherein the movement preventing portion comprises at least one of a step, a notch, a groove, and a protrusion.

16. A screen protector used with a liquid crystal display apparatus, comprising:
a display panel having a display surface to display an image;
a sheet formed on the display surface of the display panel;
a first coating layer formed on a surface of the acrylic sheet opposite to the display surface of the display panel;
a second coating layer formed on a surface of the first coating layer opposite to the sheet, and having an outside surface disposed opposite to the surface of the first coating layer to display the image; and
a movement preventing portion formed on a portion of at least one of the sheet, the first coating layer, and the second coating layer, wherein the portion is disposed on a plane different from the outside surface of the second coating layer.

17. The screen protector according to claim 16, wherein the portion is spaced-apart from the display surface of the display panel by a first distance different from a second distance between the outside surface of the second coating layer and the display surface of the display panel.

18. The screen protector according to claim 16, wherein the movement preventing portion comprises at least one of a step, a notch, a groove, and a protrusion.

19. The screen protector according to claim 16, wherein the display surface, the surface of the sheet, the surface of the first coating layer, and the outside surface of the second coating layer are parallel to each other.

20. The screen protector according to claim 16, wherein the sheet comprises an acrylic sheet, the first coating layer comprises an AG coating layer, and the second coating layer comprises at least one of an AR coating layer and a fluorine coating layer.
